(19) United States
(12) Patent Application Publication
(10) Pub. No.: US 2015/0026646 A1
(43) Pub. Date: Jan. 22, 2015

(54) USER INTERFACE APPARATUS BASED ON HAND GESTURE AND METHOD PROVIDING THE SAME

(71) Applicant: Korea Electronics Technology Institute, Seongnam-si (KR)

(72) Inventors: Yang Keun AHN, Seoul (KR); Kwang Mo JUNG, Yongin-si (KR); Young Choong PARK, Seoul (KR); Kwang Soon CHOI, Goyang-si (KR)

(73) Assignee: Korea Electronics Technology Institute, Seongnam-si (KR)

(21) Appl. No.: 14/073,415

(22) Filed: Nov. 6, 2013

(30) Foreign Application Priority Data
Jul. 18, 2013 (KR) 10-2013-0084840

(51) Int. Cl. G06F 3/0488

(52) U.S. Cl. CPC G06F 3/04883
USPC 715/863

(57) ABSTRACT

Provided is a user interface (UI) apparatus based on a hand gesture. The UI apparatus includes an image processing unit configured to detect a position of an index finger and a center position of a hand from a depth image obtained by photographing a user's hand, and detect a position of a thumb on a basis of the detected position of the index finger and the detected center position of the hand, a hand gesture recognizing unit configured to recognize a position change of the index finger and a position change of the thumb, and a function matching unit configured to match the position change of the index finger to a predetermined first function, match the position change of the thumb to a predetermined second function, and output a control signal for executing each of the matched functions.

### CROSS-REFERENCE TO RELATED APPLICATIONS

This application claims priority under 35 U.S.C. §119 to Korean Patent Application No. 10-2013-0084840, filed on Jul. 18, 2013, the disclosure of which is incorporated herein by reference in its entirety.

### TECHNICAL FIELD

The present invention relates to a user interface (UI) or an apparatus for providing a user's experience to a terminal, and more particularly, to a method and an apparatus that recognize a user's hand gesture by using a depth camera, and provide a contactless UI to a terminal on the basis of the recognized hand gesture.

### BACKGROUND

The use of electronic devices are generalized over the past few decades. In particularly, due to the advance of electronic technology, the cost of useful electronic devices having a more complicated configuration is reduced. As the cost is reduced and the consumer demand increases, the use of electronic devices capable of ubiquitous computing is expanded at present. As the use of electronic devices is expanded, the demand for new electronic devices with enhanced features increases. In more detail, it is often required to develop electronic devices that carry out functions at a higher speed, a higher efficiency, and a higher quality.

A number of electronic devices use one or more interfaces while performing an operation. For example, in computers, a keyboard and a mouse are often used for acquiring a user input for an interaction. In electronic devices in addition to computers, a touch screen and/or a touch pad are/is used for acquiring a user input for an interaction. Such an interaction needs a direct and physical interaction with a hardware piece. For example, a user should typewrite a text or a command through a keyboard. Alternatively, a user should physically move and/or push one or more buttons of a mouse so as to interact with a computer through the mouse.

In some cases, a direct interaction with a hardware piece is inconvenient or is not optimal for providing an input or a command to a computing device. For example, a user that provides a projected presentation should again access a computer each time the user desires to an interaction, causing inconvenience to the user. Furthermore, carrying an interface device such as a mouse or a wand while providing a presentation causes inconvenience to a user when the user should push a directional pad to provide an input or when the user is unskilled with a method of operating the interface device. Therefore, an improved system and method for providing a computing device interface are useful.

### SUMMARY

Accordingly, the present invention provides a method and an apparatus that recognize a user's hand gesture by using a depth camera, and provide a contactless UI to a terminal on the basis of the recognized hand gesture.

The object of the present invention is not limited to the aforesaid, but other objects not described herein will be clearly understood by those skilled in the art from descriptions below.

In one general aspect, a user interface (UI) apparatus based on a hand gesture includes: an image processing unit configured to detect a position of an index finger and a center position of a hand from a depth image obtained by photographing a user's hand, and detect a position of a thumb on a basis of the detected position of the index finger and the detected center position of the hand; a hand gesture recognizing unit configured to recognize a position change of the index finger and a position change of the thumb; and a function matching unit configured to match the position change of the index finger to a predetermined first function, match the position change of the thumb to a predetermined second function, and output a control signal for executing each of the matched functions.

The image processing unit may detect a hand region of the user by separating a foreground and a background in the depth image, and detect an uppermost portion of an edge line, which is generated by labeling the detected hand region of the user, as the position of the index finger of the user's hand.

The image processing unit may detect a hand region of the user by separating a foreground and a background in the depth image, generate a distance transformation image in units of a pixel from an image of the detected hand region of the user, and detect, as the center position of the hand, a pixel having a highest value in the distance transformation image.

The image processing unit may detect a hand region of the user by separating a foreground and a background in the depth image, generate an edge line by labeling the detected hand region of the user, search for the position of the index finger in a counterclockwise direction with respect to the position of the index finger, and detect, as the position of the thumb, a pixel of the edge line which is farthest away from the center of the hand within a predetermined angle range with respect to a straight line which connects the position of the index finger and the center position of the hand.

The hand gesture recognizing unit may compare a distance between the center position of the hand and a position of the thumb detected from a first image and a distance between the center position of the hand and a position of the thumb detected from a second image, which is captured at a time different from a time of the first image, to recognize a position change of the thumb.

When a distance between the position of the thumb and the center position of the hand in an image captured at an arbitrary time is less than a predetermined reference value, the hand gesture recognizing unit may determine there to be an event.

The image processing unit may include: a foreground/background separator configured to separate a foreground and a background on a basis of depth information in the depth image; an index finger detector configured to detect the index finger from a hand region image of the user of which the foreground and the background have been separated from each other; a hand center detector configured to a center of the user from the hand region image of the user of which the foreground and the background have been separated from each other; and a thumb detector configured to detect the thumb from the hand region image of the user on a basis of the detected index finger and the detected center of the hand.

In another general aspect, a method of providing a user interface (UI) based on a hand gesture includes: performing an image processing operation of detecting a position of an index finger and a center position of a hand from a depth image obtained by photographing a user's hand, and detecting a position of a thumb on a basis of the detected position of the index finger and the detected center position of the hand; performing a hand gesture recognizing operation of recognizing a position change of the index finger and a position change of the thumb; and performing a function matching operation of matching the position change of the index finger to a predetermined first function, matching the position change of the thumb to a predetermined second function, and outputting a control signal for executing each of the matched functions.

The image processing operation may include: detecting a hand region of the user by separating a foreground and a background in the depth image, and labeling the detected hand region of the user to generate an edge line; detecting an uppermost portion of the edge line as the position of the index finger; generating a distance transformation image in units of a pixel from an image of the hand region, and detecting, as the center position of the hand, a pixel having a highest value in the distance transformation image; and searching for the edge line in a counterclockwise direction with respect to the position of the index finger, and detecting, as the position of the thumb, a pixel of the edge line which is farthest away from the center of the hand within a predetermined angle range with respect to a straight line which connects the position of the index finger and the center position of the hand.

The hand gesture recognizing operation may include: calculating a distance a position of the index finger detected from a first image and a position of the index finger detected from a second image, which is captured at a time different from a time of the first image, and recognizing a position change of the index finger on a basis of the calculated distance; and comparing a distance between the center position of the hand and a position of the thumb detected from the first image and a distance between the center position of the hand and a position of the thumb detected from the second image to recognize a position change of the thumb.

The hand gesture recognizing operation may include determining there to be an event when a distance between the position of the thumb and the center position of the hand in an image captured at an arbitrary time is less than a predetermined reference value.

Other features and aspects will be apparent from the following detailed description, the drawings, and the claims.

### BRIEF DESCRIPTION OF THE DRAWINGS

FIG. 1 is a diagram illustrating a system environment in which a UI apparatus based on a hand gesture according to an embodiment of the present invention is provided.

FIG. 2 is a block diagram illustrating a UI apparatus based on a hand gesture according to an embodiment of the present invention.

FIG. 3 is a block diagram illustrating an internal configuration of an image processing unit of FIG. 2.

FIG. 4 is an exemplary diagram showing a result of an edge line detected by labeling a hand region.

FIG. 5 is an exemplary diagram showing a result of a distance transformation image of a hand region which is generated for detecting the center of a hand, according to an embodiment of the present invention;

FIG. 6 is an exemplary diagram for describing a method of detecting the center of a hand according to an embodiment of the present invention;

FIG. 7 is an exemplary diagram for describing a method of detecting a thumb according to an embodiment of the present invention;

FIG. 8 is an exemplary diagram for describing a method of detecting a thumb state according to an embodiment of the present invention; and

FIG. 9 is a flowchart illustrating a UI providing method based on a hand gesture according to an embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the present invention. The terms of a singular form may include plural forms unless specifically mentioned.

Hereinafter, embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

The term “wireless communication device” used herein is referred to as an electronic device (for example, an access terminal, a client terminal, a client station, or the like) that wirelessly communicates with a base station or another electronic device. The wireless communication device may be referred to as a mobile device, a mobile station, a subscription station, a user equipment (UE), a remote station, an access terminal, a mobile terminal, a terminal, a user terminal, and a subscriber unit. Examples of the wireless communication device include laptop computers (or desktop computers), cellular phones, smartphones, wireless modems, e-readers, tablet devices, and gaming systems. The wireless communication devices may operate according to one or more standards (for example, third-generation partnership project (3GPP), Wi-Max, IEEE 802.11, or Wi-Fi). Therefore, the general term “wireless communication device” may include wireless communication devices (for example, access terminals, UEs, remote terminals, etc.) described by various nomenclatures based on industrial standards.

FIG. 1 is a diagram illustrating a system environment in which a UI apparatus based on a hand gesture according to an embodiment of the present invention is provided.

As illustrated in FIG. 1, the UI apparatus based on a hand gesture according to an embodiment of the present invention may be used to control an object in a terminal including a depth camera. For example, a user controls and clicks a position of a mouse cursor with a hand gesture at a long distance, and thus provides a mouse input that selects or drags an object displayed on a screen of the terminal.

The user opens a thumb and an index finger to make a V-shape of a hand, and the depth camera photographs the V-shaped hand to generate depth information data. Here, a position of the index finger is recognized as a position of the mouse cursor on a plane parallel to a display of the terminal, and a position change (including a position on three-dimensional (3D) coordinates in addition to a position change on a two-dimensional (2D) plane) of the thumb is recognized as a click event.

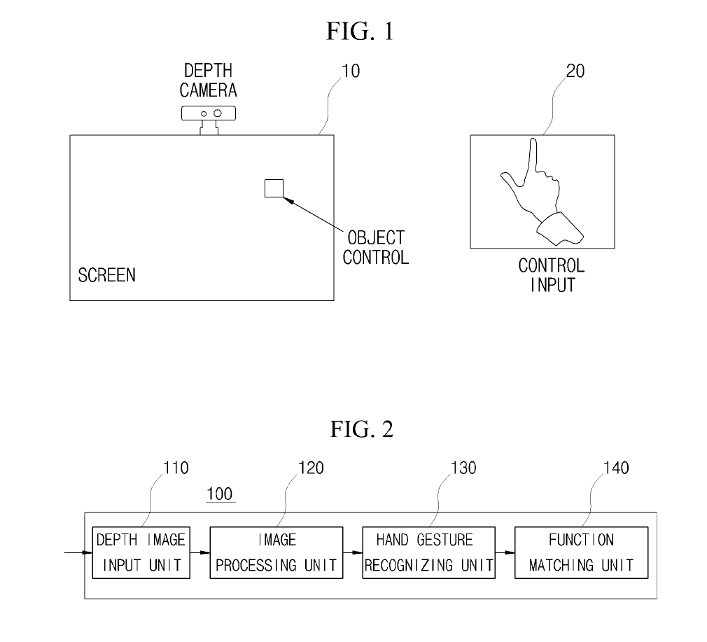

Hereinafter, the UI apparatus, based on a hand gesture, which performs the above-described function will be described in detail with reference to FIGS. 2 to 8. FIG. 2 is a block diagram illustrating a UI apparatus based on a hand gesture according to an embodiment of the present invention.

Referring to FIG. 2, the UI apparatus based on a hand gesture according to an embodiment of the present invention includes a depth image input unit 110, an image processing unit 120, a hand gesture recognizing unit 130, and a function matching unit 140.

Data of an image, captured by a depth camera equipped in a terminal, is inputted to the depth image input unit 110. The depth camera generates distance information to an object in a scene. For example, a representative example of the depth camera includes a camera using time-of-flight (TOF) technology. The depth camera transmits an infrared or optical signal to the scene, measures a distance by using a phase difference between the transmitted signal and a signal reflected by an object, and outputs the measured distance as a depth image.

The image processing unit 120 processes the depth image, which is input to the depth image input unit 110, to detect a position of an index finger and a center position of a hand from the depth image including a user's hand photographed by the depth camera, and detects a position of a thumb on the basis of the detected position of the index finger and the detected center position of the hand.

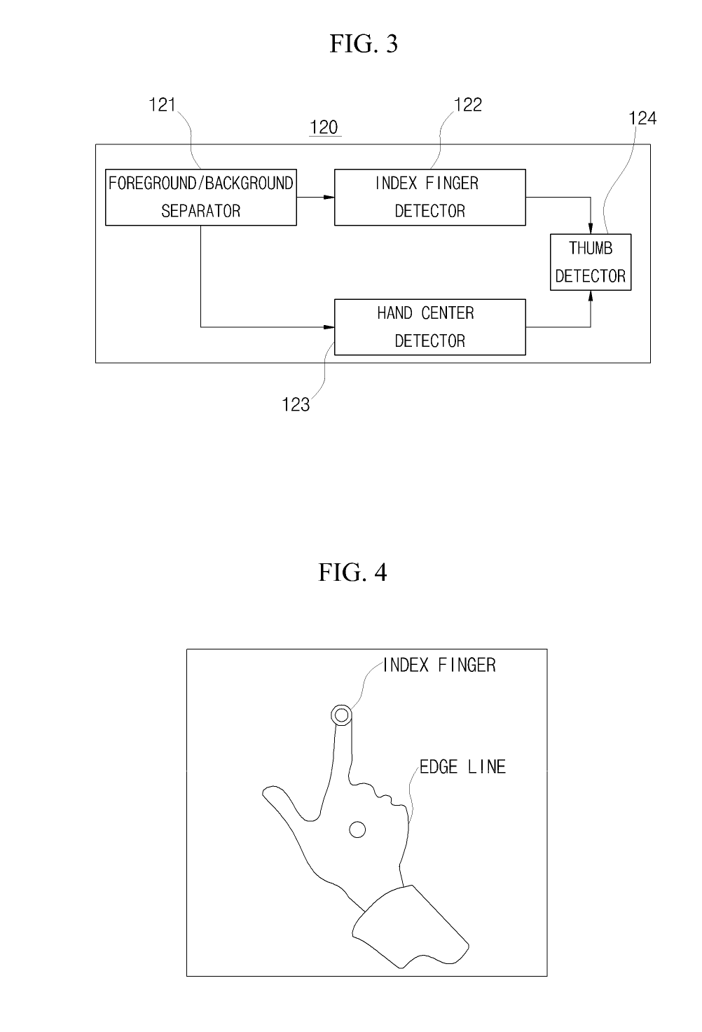

The image processing unit 120, as illustrated in FIG. 3, may include a foreground/background separator 121, an index finger detector 122, a hand center detector 123, and a thumb detector 124.

The foreground/background separator 121 separates an object (a foreground) and a background by using pixel-unit depth information data acquired from an image captured by the depth camera. This is for separating extracting a hand region from the captured depth image. In detail, the foreground/background separator 121 finds a region closest to the depth camera in the depth image, extracts a predetermined distance (a distance, for example, 5 cm, to the depth camera) as a hand region from the found region, and binarizes a hand image in a corresponding distance field in units of a pixel.

The thumb detector 122 performs labeling on a hand region image obtained through the pixel-unit binarization by the foreground/background separator 121 to generate an edge line, and detects the uppermost portion of the edge line as a position of the index finger of the user's hand.

The labeling, an image processing technique, is an image processing algorithm which is mainly used when distinguishing object regions separated from each other in an image. As the labeling result, the edge line between a hand region and a region other than the hand region is generated, and a detailed shape of the edge line is as shown in FIG. 4.

The index finger detector 122 detects, as a position of the index finger, a pixel which is at the uppermost portion among a plurality of pixels included in the edge line. For example, the index finger detector 122 searches for y-coordinate values of the pixels included in the edge line, and determines a pixel having the highest value as the position of the index finger.

The hand center detector 123 generates a distance transformation image in units of a pixel from the binarized hand region image, and detects, as the center position of the hand, a pixel having the highest value in the distance transformation image.

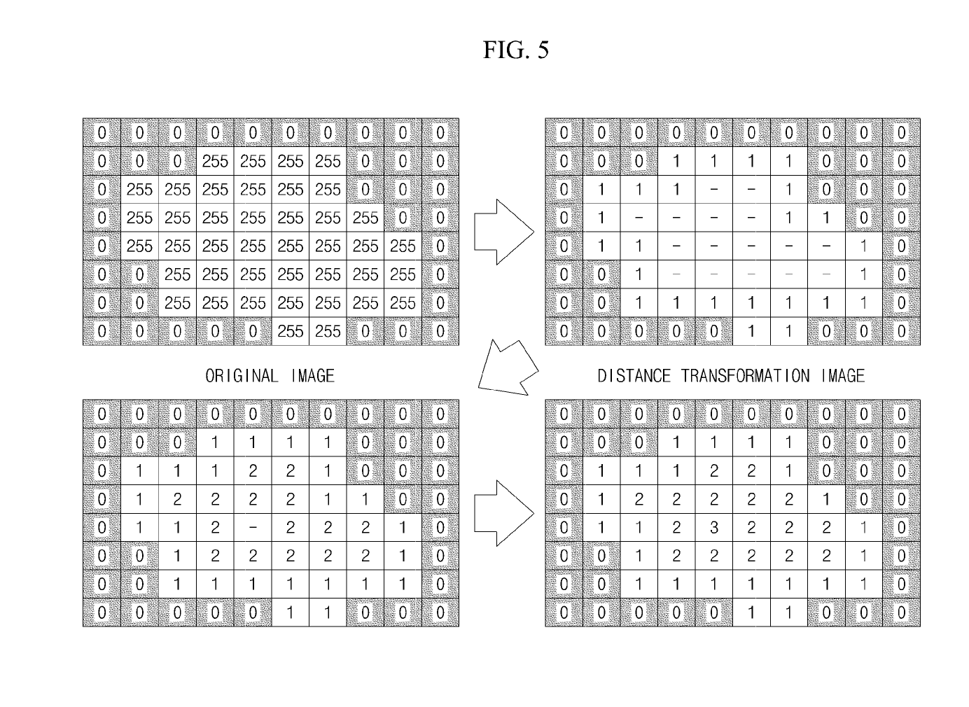

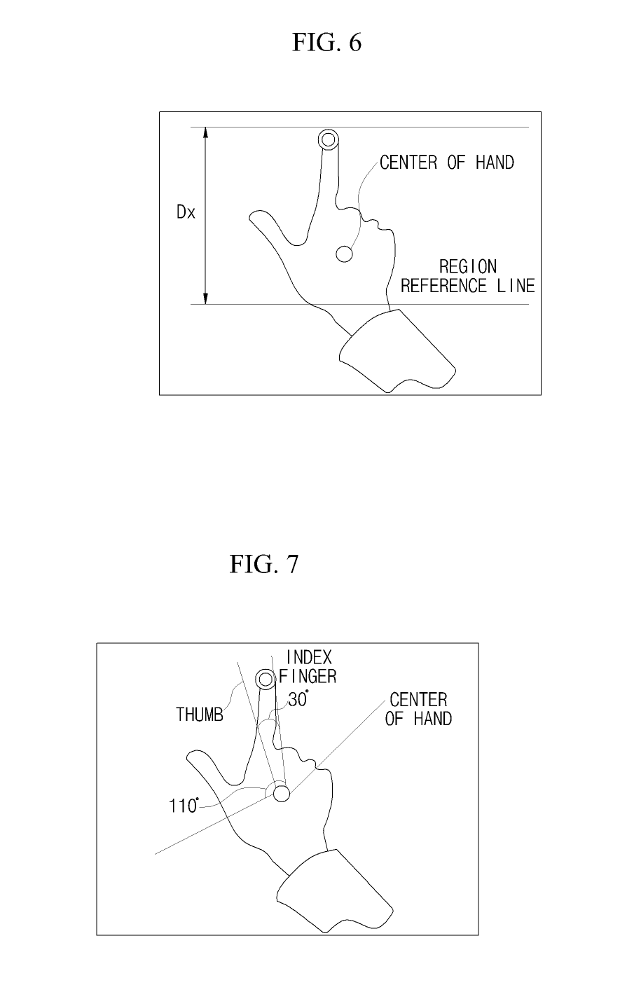

FIG. 5 is an exemplary diagram showing a result of a distance transformation image of a hand region which is generated for detecting the center of a hand, according to an embodiment of the present invention, FIG. 6 is an exemplary diagram for describing a method of detecting the center of a hand according to an embodiment of the present invention.

A method, which generates a distance transformation image and detects the center of a hand by using the distance transformation image, will be described with reference to FIGS. 5 and 6. The method cuts an image by a predetermined distance Dx with respect to a position value (a y-coordinate value) of an index finger which is determined by the index finger detector 122, and generates a distance transformation image from only the cut image.

The distance transformation image denotes an image that, after calculating a distance value to a pixel having a value “0” closest to each of a plurality of pixels of the original image, has the calculated distance value as each pixel value. As shown in FIG. 5, in a hand region, a pixel closest to the original image for which distance transformation is intended has a value “0”, and a distance value between each pixel of the original image and the pixel having the value “0” is calculated. A pixel, which is closest to the pixel having the value “0”, of the original image has a pixel value “1”, a next pixel has a pixel value “2”, and the farthest pixel has a pixel value “3”. Since the center of the hand is farthest away from an outer portion of the hand, a pixel having the highest distance value is extracted as the center of the hand.

The thumb detector 124 detects a thumb from the binarized hand region image by using the detected position of the index finger and the detected center position of the hand.

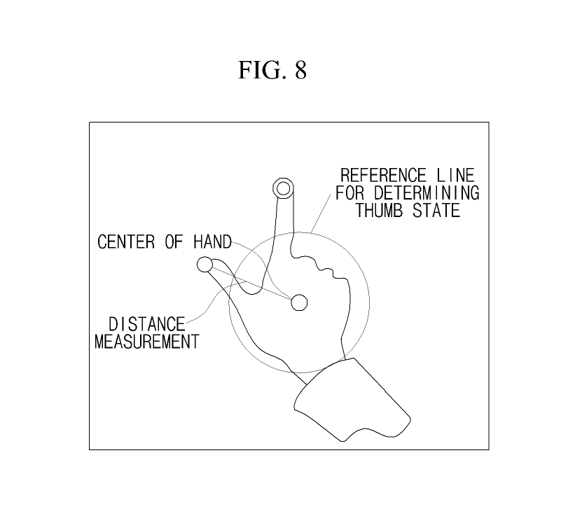

In an embodiment, as shown in FIGS. 7 and 8, the thumb detector 124 searches for the edge line, generated by the labeling, in units of a pixel in a counterclockwise direction with respect to the position of the thumb. In this case, the thumb is farthest away from the center of the hand, and thus, a pixel of the edge line which is farthest away from the center of the hand is detected as the thumb.

Specifically, the thumb detector 124 searches for the edge line in the counterclockwise direction from the position of the index finger, and detects, as the position of the thumb, a pixel of the edge line which is farthest away from the center of the hand within a predetermined angle range (generally, it is assumed that an angle between the index finger and the center of the hand and an angle between the index finger and the thumb are within 30 degrees to 110 degrees.) with respect to a straight line which connects the position of the index finger and the center position of the hand.

The hand gesture recognizing unit 130 recognizes a change in each of the detected positions of the index finger and thumb.

In an embodiment, the hand gesture recognizing unit 130 compares a position of the index finger detected from a first image and a position of the index finger detected from a second image, which is captured at a time different from that of the first image, to calculate a distance between the positions, and recognizes a position change of the index finger on the basis of the calculated distance.

In another embodiment, the hand gesture recognizing unit 130 compares a distance between a position of the thumb detected from the first image and the center position of the hand and a distance between a position of the thumb detected from the second image and the center position of the hand, thereby recognizing a position change of the thumb.

In another embodiment, the hand gesture recognizing unit 130 calculates a distance between the position of the thumb and the center position of the hand in an image which is captured at an arbitrary time, and compares a predetermined reference value and the calculated distance between the position of the thumb and the center position of the hand. When the calculated distance is less than the reference value, the hand gesture recognizing unit 130 determines there to be a change in the position of the index finger.

The function matching unit 140 matches the position change of the index finger to a predetermined first function, matches the position change of the thumb to a predetermined second function, and outputs a control signal for executing each of the matched functions.

For example, the function matching unit 140 may match the position change of the index finger to a position change of a mouse pointer, and may match the position change of the thumb to a function that selects or executes an object included in the terminal.

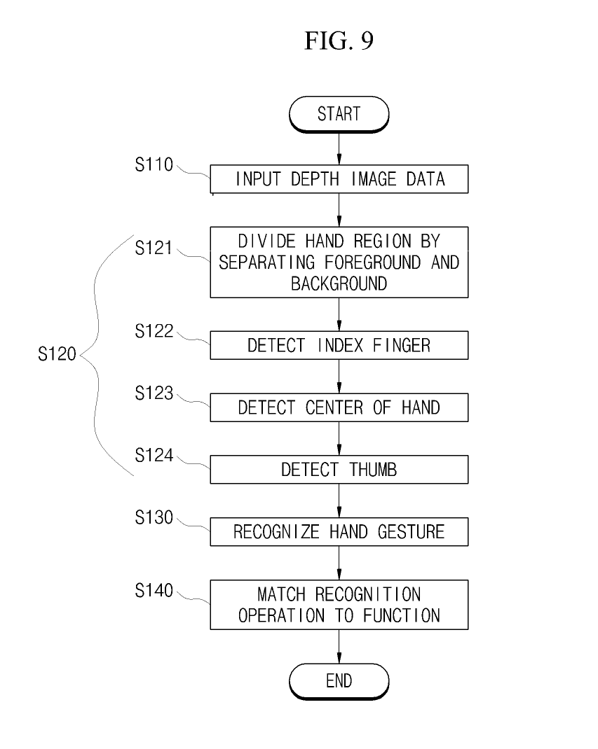

A method, in which the UI apparatus based on a hand gesture provides a UI, will be described in detail with reference to FIG. 9. FIG. 9 is a flowchart illustrating a UI providing method based on a hand gesture according to an embodiment of the present invention.

Referring to FIG. 9, the UI providing method based on a hand gesture according to an embodiment of the present invention includes: operation S110 that inputs depth image data; operation S121 that divides a hand region by separating a foreground and a background; operation S122 that detects an index finger from an image of the hand region; operation S123 that detects the center of a hand from the image of the hand image; operation S124 that detects a thumb from the image of the hand region; operation S130 that recognizes a position change of the detected index finger and a position change of the detected thumb; and operation S140 that matches the recognized hand gesture to a function.

The operations for providing the UI based on a hand gesture have been above in detail, and thus, their detailed descriptions are not provided.

As described above, according to the present invention, a user realizes a function with the user's hand gesture at a long distance even without using a separate control device such as a remote controller, and thus, there is no economic burden, and convenience in use is provided.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user interface (UI) apparatus based on a hand gesture, the UI apparatus comprising:
an image processing unit configured to detect a position of an index finger and a center position of a hand from a depth image obtained by photographing a user's hand, and detect a position of a thumb on a basis of the detected position of the index finger and the detected center position of the hand;
a hand gesture recognizing unit configured to recognize a position change of the index finger and a position change of the thumb; and
a function matching unit configured to match the position change of the index finger to a predetermined first function, match the position change of the thumb to a predetermined second function, and output a control signal for executing each of the matched functions.

2. The UI apparatus of claim 1, wherein the image processing unit detects a hand region of the user by separating a foreground and a background in the depth image, and detects an uppermost portion of an edge line, which is generated by labeling the detected hand region of the user, as the position of the index finger of the user's hand.

3. The UI apparatus of claim 1, wherein the image processing unit detects a hand region of the user by separating a foreground and a background in the depth image, generates a distance transformation image in units of a pixel from an image of the detected hand region of the user, and detects, as the center position of the hand, a pixel having a highest value in the distance transformation image.

4. The UI apparatus of claim 1, wherein the image processing unit detects a hand region of the user by separating a foreground and a background in the depth image, generates an edge line by labeling the detected hand region of the user, searches for the position of the index finger in a counterclockwise direction with respect to the position of the index finger, and detects, as the position of the thumb, a pixel of the edge line which is farthest away from the center of the hand within a predetermined angle range with respect to a straight line which connects the position of the index finger and the center position of the hand.

5. The UI apparatus of claim 1, wherein the hand gesture recognizing unit compares a distance between the center position of the hand and a position of the thumb detected from a first image and a distance between the center position of the hand and a position of the thumb detected from a second image, which is captured at a time different from a time of the first image, to recognize a position change of the thumb.

6. The UI apparatus of claim 1, wherein when a distance between the position of the thumb and the center position of the hand in an image captured at an arbitrary time is less than a predetermined reference value, the hand gesture recognizing unit determines there to be an event.

7. The UI apparatus of claim 1, wherein the image processing unit comprises:
a foreground/background separator configured to separate a foreground and a background on a basis of depth information in the depth image;
an index finger detector configured to detect the index finger from a hand region image of the user of which the foreground and the background have been separated from each other;
a hand center detector configured to a center of the user from the hand region image of the user of which the foreground and the background have been separated from each other; and
a thumb detector configured to detect the thumb from the hand region image of the user on a basis of the detected index finger and the detected center of the hand.

8. A method of providing a user interface (UI) based on a hand gesture, the method comprising:
performing an image processing operation of detecting a position of an index finger and a center position of a hand from a depth image obtained by photographing a user's hand, and detecting a position of a thumb on a basis of the detected position of the index finger and the detected center position of the hand;
performing a hand gesture recognizing operation of recognizing a position change of the index finger and a position change of the thumb; and
performing a function matching operation of matching the position change of the index finger to a predetermined first function, matching the position change of the thumb to a predetermined second function, and outputting a control signal for executing each of the matched functions.

9. The method of claim 8, wherein the image processing operation comprises:
detecting a hand region of the user by separating a foreground and a background in the depth image, and labeling the detected hand region of the user to generate an edge line;
detecting an uppermost portion of the edge line as the position of the index finger;
generating a distance transformation image in units of a pixel from an image of the hand region, and detecting, as the center position of the hand, a pixel having a highest value in the distance transformation image; and
searching for the edge line in a counterclockwise direction with respect to the position of the index finger, and detecting, as the position of the thumb, a pixel of the edge line which is farthest away from the center of the hand within a predetermined angle range with respect to a straight line which connects the position of the index finger and the center position of the hand.

10. The method of claim 8, wherein the hand gesture recognizing operation comprises:
calculating a position of the index finger detected from a first image and a position of the index finger detected from a second image, which is captured at a time different from a time of the first image, and recognizing a position change of the index finger between the first image and the second image; and
comparing a distance between the center position of the hand and a position of the thumb detected from the first image and a distance between the center position of the hand and a position of the thumb detected from the second image to recognize a position change of the thumb.

11. The method of claim 8, wherein the hand gesture recognizing operation comprises determining there to be an event when a distance between the position of the thumb and the center position of the hand in an image captured at an arbitrary time is less than a predetermined reference value.
